(19) United States
(12) Patent Application Publication
(10) Pub. No.: US 2015/0143071 A1
(43) Pub. Date: May 21, 2015

(54) MEMORY EVENT NOTIFICATION

(71) Applicants: Ravi L. Sahita, Portland, OR (US); Yasser Rasheed, Beaverton, OR (US); Vedvyas Shanbhogue, Austin, TX (US); David M. Durham, Beaverton, OR (US); Scott H. Robinson, Portland, OR (US); Paul S. Schmitz, North Plains, OR (US)

(72) Inventors: Ravi L. Sahita, Portland, OR (US); Yasser Rasheed, Beaverton, OR (US); Vedvyas Shanbhogue, Austin, TX (US); David M. Durham, Beaverton, OR (US); Scott H. Robinson, Portland, OR (US); Paul S. Schmitz, North Plains, OR (US)

(21) Appl. No.: 13/995,337

(22) PCT Filed: Dec. 30, 2011
(86) PCT No.: PCT/US2011/068118

§ 371 Date: Jun. 18, 2013

(51) Int. Cl. G06F 12/10; G06F 21/55

(52) U.S. Cl. CPC G06F 12/10; G06F 21/554; G06F 2212/251; G06F 2221/034
USPC 711/202

(57) ABSTRACT

Embodiments of apparatuses and methods for memory event notification are disclosed. In one embodiment, a processor includes address translation hardware and memory event hardware. The address translation hardware is to support translation of a first address, used by software to access a memory, to a second address, used by the processor to access the memory. The memory event hardware is to detect an access to a registered portion of memory.

### BACKGROUND

1. Field

The present disclosure pertains to the field of information processing, and more particularly, to the field of security in information processing systems.

2. Description of Related Art

Many malware attacks on information processing systems involve the manipulation of memory. For example, an attack may involve storing malicious code or data in memory, then exploiting bugs and/or buffer overflows while running legitimate programs to transfer control to the malicious code to use the malicious data.

### BRIEF DESCRIPTION OF THE FIGURES

The present invention is illustrated by way of example and not limitation in the accompanying figures.

FIG. 1 illustrates an information processing system in which an embodiment of the present invention may be present and/or operate.

FIG. 2 illustrates a method for memory event notification according to an embodiment of the present invention.

### DETAILED DESCRIPTION

Embodiments of apparatuses, methods, and systems for memory event notification are described below. In this description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

Embodiments of the present invention may be used for notifying security software of memory events. Therefore, embodiments of the present invention may provide a tool for security software to use against malware attacks that involve the manipulation of memory. Embodiments of the present invention may be used together with other approaches to information processing security, such as techniques to partition system memory to provide isolated or protected execution environments for different application programs.

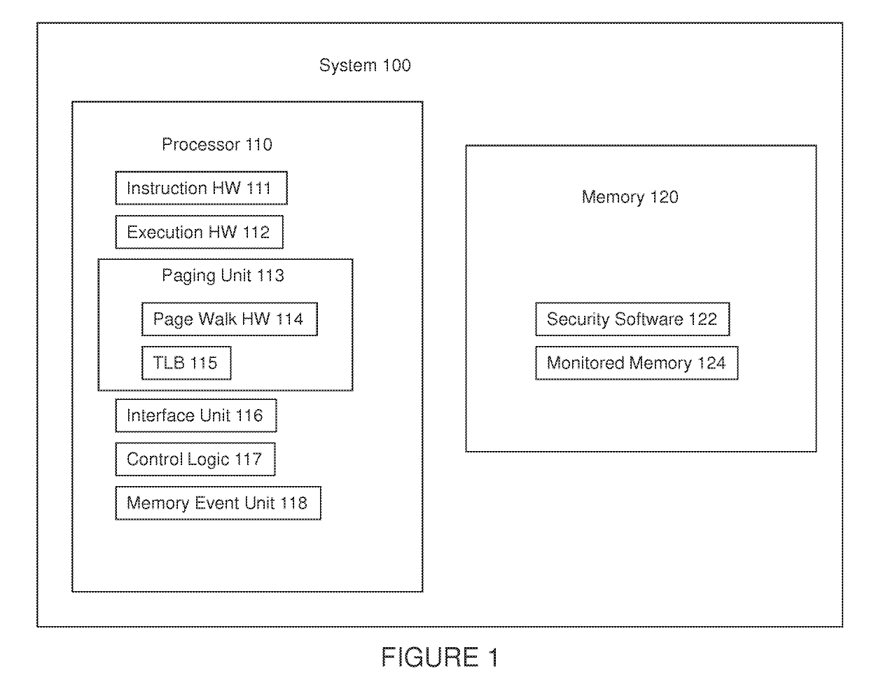

FIG. 1 illustrates system 100, an information processing system in which an embodiment of the present invention may be present and/or operate. System 100 may represent any type of information processing system, such as a server, a desktop computer, a portable computer, a set-top box, a hand-held device, or an embedded control system. System 100 includes processor 110 and memory 120. Systems embodying the present invention may include number of each of these components and any other components or other elements. Any or all of the components or other elements in any system embodiment may be connected, coupled, or otherwise in communication with each other through any number of buses, point-to-point, or other wired or wireless connections.

Processor 110 may represent any type of processor, including a general purpose microprocessor, such as a processor in the Core® Processor Family, or other processor family from Intel Corporation, or another processor from another company, or any other processor for processing information according to an embodiment of the present invention. Processor 110 may include any number of execution cores and/or support any number of execution threads, and therefore may represent any number of physical or logical processors, and/or may represent a multi-processor component or unit.

Memory 120 may represent any static or dynamic random access memory, semiconductor-based read only or flash memory, magnetic or optical disk memory, any other type of medium accessible by processor 110 and/or other elements of system 100, or any combination of such mediums. Memory 120 may represent a system memory in which data and instructions, including operating system instructions, virtual machine monitor instructions, and application program instructions may be stored. Embodiments of the present invention may provide for security software 122 to be stored in memory 120, and for portion(s) 124 of memory 120 to be monitored as described below. Monitored memory portion(s) 124 may be of any site and may be used for any purpose, such as to store operating system code and/or data structures including page table, interrupt descriptor tables, and system service dispatch tables, each of which may be a target of mal are attacks.

Processor 110 may include instruction hardware 111, execution hardware 112, paging unit 113, interface unit 116, control logic 117, and memory event unit 118, plus any other units or elements.

Instruction hardware 111 may represent any circuitry, structure, or other hardware, such as an instruction decoder, for fetching, receiving, decoding, and/or scheduling instructions. Any instruction format may be used within the scope of the present invention; for example, an instruction may include an opcode and one or more operands, where the opcode may be decoded into one or more micro-instructions or micro-operations for execution by execution hardware 112.

Execution hardware 112 may include any circuitry, structure, or other hardware, such as an arithmetic unit, logic unit, floating point unit, shifter, etc., for processing data and executing instructions, micro-instructions, and/or micro-operations.

Paging unit 113 may represent any circuitry, structure, or other hardware for translating addresses with which processor 110 accesses memory 120. Paging unit 113 may perform address translations, for example the translation of a logical or linear address to a physical address, according to any known memory management technique, as part of a memory management technique to provide processor 110 with a virtual address space that is larger than the size of memory 120. To perform address translations, paging unit 113 refers to one or more data structures stored in processor 110, memory 120, any other storage location in system 100 not shown in FIG. 1, and/or any combination of these components and locations. The data structures may include page directories and page tables according to the architecture of the Core® Processor Family.

In one embodiment, paging unit 113 receives a linear address provided by an instruction to be executed and/or of data to be fetched by processor 110. Paging unit 113 uses portions of the linear address as indices into hierarchical tables, including page tables. The page tables contain entries, each including a field for a base address of a page in memory 120. Any page size (e.g., 4 kilobytes) may be used within the scope of the present invention. Therefore, the linear address used by a program to access memory 120 may be translated to a physical address used by processor 110 to access memory 120. Address translation may involve addition complexities, such as would be the case for the translation of a linear address used by guest software within a virtual machine to a physical address used by host software such as a virtual machine monitor to access memory 120.

Paging unit 113 may include page walk hardware 114 for traversing the hierarchy of the paging data structure from a linear address to a physical address, and translation lookaside buffer 115 for storing address translations and provide for the paging data structure to be bypassed.

Interface unit 116 may represent any circuitry, structure, or other hardware, such as a bus unit or any other unit, port, or interface, to allow processor 110 to communicate with other components in system 100 through any type of bus, point to point, or other connection, directly or through any other component, such as a memory controller or a bus bridge.

Control logic 117 may represent microcode, programmable logic, hard-coded logic, or any other type of logic to control the operation of the units and other elements of processor 110 and the transfer of data within, into, and out of processor 110. Control logic 118 may cause processor 110 to perform or participate in the performance of method embodiments of the present invention, such as the method embodiments described below, for example, by causing processor 110 to execute instructions received by instruction hardware 112 and micro-instructions or micro-operations derived from instructions received by instruction hardware 112.

Memory event unit 118 may represent any circuitry, structure, or other hardware to determine whether a memory access is to a registered area of memory, according to embodiments of the invention further described below. Memory event unit 118 may work in connection with other hardware, firmware, software, and/or data structures to provide a notification upon detecting an access to registered memory, and to perform other actions according to embodiments of the invention further described below. For example, a data structure (e.g., a hash table) referred to as a physical memory monitor table (“PMMT”) may be used to register physical memory pages, corresponding to monitored memory portion 124, to which accesses are to be monitored and/or reported. Each PMMT entry may include a field for the address of a physical page, and any number of bits locations and/or fields to store access policy information, as further described bellow. The hardware of memory event unit 118, along with any other such hardware, firmware, software, and/or data structures may be referred to as memory event logic. However, memory event logic is rooting in the hardware of memory event unit 118 such that memory event detection and notification cannot be circumvented by software.

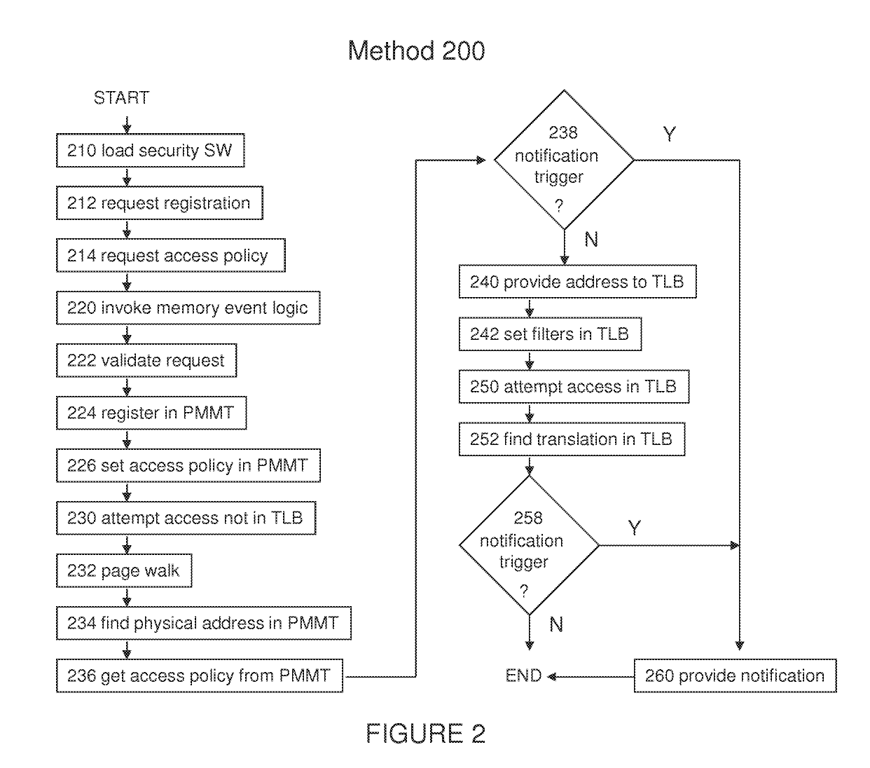

FIG. 2 illustrates method 200 for memory event notification according to an embodiment of the present invention. The description of FIG. 2 may refer to elements of FIG. 1, but method 200 and other method embodiments of the present invention are not intended to be limited by these references.

In box 210, security software 122 may be authenticated and loaded into a memory partition that is isolated or protected according to any known approach. In box 212, security software 122 running on processor 110 requests the registration of a portion 124 of memory 120 for monitoring. The request may specify the location of the memory portion to be monitored based. on the information available to security software 122 (e.g., one or more physical addresses, or one or more linear addresses along with a page directory pointer). In box 214 security software 122 requests an access policy, as further described below, to be applied for detected accesses to monitored memory portion 124.

In box 220, memory event logic may be invoked to evaluate the request. Box 220 may be performed or facilitated by an isolated environment scheduler in accordance with the approach used to maintain the isolated execution environment for security software 122 and other software. In box 222, memory event logic may validate the request to determine whether the request is authorized and whether the requested access policies may be applied. In box 224, memory event logic may register the physical memory pages corresponding to monitored memory portion 124 in the PMMT. In box 226, memory event logic may set the access policies for monitored memory portion 124 in the PMMT.

In box 230, an access to a memory location having a linear address corresponding to a registered physical page may be attempted, where the translation is not in TLB 115. The attempt may be made by any software (or component or device on behalf of any software), malicious or not. In box 232, page walk hardware 114 translates the linear address to a physical address. In box 234, the physical address is found in the PMMT. In box 236, the access policies for the registered page are provided to page walk hardware 114. In box 238, a memory event notification may be triggered, based on the access policies, in which case method 200 may continue in box 260.

In box 240, page walk hardware 114 provides the address translation to TLB 115 in box 242, page walk handler 114 sets access restrictions or other filters on the translation in TLB 115, according to the access policies.

In box 250, an access to a memory location having a linear address corresponding to a registered physical page may be attempted, where the translation may be found in TLB 115. The attempt may be made by any software (or component or device on behalf of any software), malicious or not. In box 252 the translation is found in TLB 115. In box 258 a memory event notification may be triggered, based on the access policy filters, in which case method 200 may continue in box 260.

In box 260, the memory event logic may provide notification of a memory access to a registered physical page. Many variations of the approach to notification are possible, and may depend on the access policies. Embodiments of the present invention may support any one or any combination of access policies and/or notification approaches.

For example, access policies may include enabling the notification mechanism upon any (or any combination) of the following events: an attempt to read from the page, an attempt to write to the page, an attempt to execute from the page, a first attempt to access the page, any attempt to access the page, etc. Access policies may also include information to specify a type (or any combination of types) of notification: logging the access, allowing the access, denying the access, etc.

Depending on the access policy and the notification approach, box 260 may include any or all of the following: causing an exception or a fault, reporting the event to the requesting security software (e.g., through the isolated environment scheduler), waiting for a response from the security software before allowing the access (“synchronous reporting”), and allowing the access and reporting to the security software that the access was allowed (“asynchronous reporting”).

The reporting, logging, and/or exception or fault information may include any (or any combination) of the following: an identifier associated with the event, the address accessed or attempted to be accessed, the cause of the event, the response to the event.

Within the scope of the present invention, the method illustrated in FIG. 2 may be performed in a different order, with illustrated boxes omitted, with additional boxes added, or with a combination of reordered, omitted, or additional boxes.

Thus, apparatuses, methods, and systems for memory event notification have been disclosed. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
address translation hardware to support translation of a first address to a second address, wherein the first address is used by software to access a memory and the second address is used by the processor to access the memory; and
memory event hardware to detect an access to a registered portion of the memory.

2. The processor of claim 1, wherein the memory event hardware is also to provide a notification of the access.

3. The processor of claim 1, wherein the memory event hardware is to provide the notification by causing an exception.

4. The processor of claim 1, wherein the memory event hardware is also to register the portion of the memory in a memory monitor table.

5. The processor of claim 4, wherein the memory event hardware is also to store access policy information for the portion of the memory in the memory monitor table.

6. The processor of claim 5, wherein the memory event hardware is to refer to the memory monitor table to determine a response to the access based on an access policy.

7. A method comprising:
translating, by address translation hardware in a processor, a first address to a second address, where the first address is used by software to access a memory and the second address is used by the processor to access a memory; and
detecting, by memory event hardware in a processor, an access to a registered portion of the memory.

8. The method of claim 7, further comprising providing notification of the access.

9. The method of claim 8, wherein providing notification includes causing an exception.

10. The method of claim 7, further comprising registering the portion the memory in a memory monitor table.

11. The method of claim 10, wherein detecting includes determining that the second address is registered in the memory monitor table.

12. The method of claim 10, further comprising storing, in the memory monitor table, access policy information associated with the portion of the memory.

13. The method of claim 12, further comprising referring to the memory monitor table to determine a response to the access.

14. The method of claim 11 wherein the response includes denying the access.

15. The method of claim 13, wherein the response includes reporting the access to security software.

16. The method of claim 15, wherein the response includes waiting for the security software to respond before allowing the access.

17. The method of claim 13, wherein the response includes logging the access.

18. A system comprising:
a memory; and
a processor including
address translation hardware to support a translation of a first address to a second address, wherein the first address is used by software to access the memory and the second address is used by the processor to access the memory; and
memory event hardware to detect an access to a registered portion of the memory.

19. The system of claim 18, wherein the memory is addressable in pages, and the registered portion of memory includes a page.

20. The system of claim 19, wherein the registered portion of memory is to store a data structure used by an operating system.
